(19) United States
(12) Patent Application Publication
(10) Pub. No.: US 2007/0115863 A1
(43) Pub. Date: May 24, 2007

(54) Dualduplexer having matrix structure and method for forming the same

(75) Inventors: Tae-Won Seo, Gyeonggi-do (JP); Young-Sang Yoon, Gyeonggi-do (JP); Sang-Jun Kim, Gyeonnggi-do (JP); Jae-Bum Noh, Seoul (KR); Young-Seob Yoo, Chungcheongbuk-do (KR)

Correspondence Address: VENABLE LLP, P.O. BOX 34385, WASHINGTON, DC, 20043-9998, US

(73) Assignee: Ktfreetel Co. LTD, Seoul (KR)

(21) Appl. No.: 10/565,243

(22) PCT Filed: Jul. 19, 2004
(86) PCT No.: PCT/KR04/01795

§ 371 Date: Jan. 19, 2006

(30) Foreign Application Priority Data
Jul. 19, 2003 (KR) 10-2003-0043519

(51) Int. Cl. H04L 5/14; H04B 1/56

(52) U.S. Cl. 370/276

(57) ABSTRACT

The present invention relates to a dualduplexer having a matrix structure and a fabrication method thereof. The dualduplexer includes a dualduplexing block which uses the transmitting input unit, the receiving input unit, the transmitting output unit and the receiving output unit in common, wherein the transmitting input unit, the receiving input unit, the transmitting output unit and the receiving output unit are connected in the form of a matrix; a low noise amplifying block for performing low noise amplification on a signal outputted from an input port of the dualduplexing block; and a high power amplifying block for performing high power amplification on the signal outputted from the low noise amplifying block and transmitting the amplified signal to the dualduplexing block.

### TECHNICAL FIELD

The present invention relates to a dualduplexer having a matrix structure and method for forming the same; and, more particularly, to a dualduplexer that can minimize the loss in transmitting and receiving paths by integrating duplexers to share a transmitting/receiving amplifier and a method for forming the dualduplexer.

### BACKGROUND ART

FIG. 1 is a block diagram illustrating a repeater using duplexers according to an embodiment of a prior art.

As shown, a transmitting (Tx) signal transmitted from a base station is inputted into a repeater 11 through a link antenna 12, filtered in a transmitting unit of a first duplexer 14, passes through a low noise amplifier (LNA) 15 and the high power amplifier (HPA) 16, and is radiated through a transmitting unit of a second duplexer 17 and a service antenna 13. On the contrary, a received (Rx) signal received through the service antenna 13 is inputted to a receiving unit of the second duplexer 17, passes through an LNA 18 and an HPA 19, and is radiated through a receiving unit of the first duplexer 14 in the direction of the base station.

According to the method described above, since duplexers are placed in a transmitting output unit and a receiving input unit, there is a shortcoming that a transmitting/receiving amplifier should be designed and fabricated separately in the respective transmitting unit and receiving unit.

To solve the problem, a method of duplicating a duplexer to share a transmitting/receiving amplifier is used.

FIG. 2 is a block diagram showing a repeater using duplexers according to another embodiment of the prior art.

As shown, a transmitting (Tx) signal transmitted from a base station is inputted to a repeater 11 through a link antenna 12, filtered in a transmitting unit of a first duplexer 14, inputted to a transmitting unit of a second duplexer 15, passes through an LNA 16, an HPA 17 and a transmitting unit of a third duplexer 18 via cable, is inputted to a transmitting unit of a fourth duplexer 19, and radiated through a service antenna 13. On the contrary, a received (Rx) signal received through the service antenna 13 is inputted to a receiving unit of the fourth duplexer 19, passes through a receiving unit of a second duplexer 15, an LNA 16 and an HPA 17 via cable, is inputted to a receiving unit of a third duplexer 18, and radiated through a receiving unit of the first duplexer 14 via cable in the direction of the base station.

Even in this method where a transmitting/receiving amplifier is shared by the transmitting unit and the receiving unit to overcome the loss generated by using a duplexer in double, which is different from the other conventional technology, there is a problem that additional expenses are needed due to the use of a dualduplexer and loss occurs in the transmitting and receiving paths.

### DISCLOSURE OF INVENTION

It is, therefore, an object of the present invention to provide a dualduplexer having a matrix structure that can minimize the loss in transmitting and receiving paths by integrating duplexers to share a transmitting/receiving amplifier so that there is little loss caused by the duplication and a method for forming the dualduplexer.

In accordance with one aspect of the present invention, there is provided a dualduplexer includes a dualduplexing block which uses the transmitting input unit, the receiving input unit, the transmitting output unit and the receiving output unit in common, wherein the transmitting input unit, the receiving input unit, the transmitting output unit and the receiving output unit are connected in the form of a matrix; a low noise amplifying block for performing low noise amplification on a signal outputted from an input port of the dualduplexing block; and a high power amplifying block for performing high power amplification on the signal outputted from the low noise amplifying block and transmitting the amplified signal to the dualduplexing block.

In accordance with another aspect of the present invention, there is provided a method for fabricating a dualduplexer having a matrix structure using an amplifying means in common, including the steps of: a) filtering a transmitting (Tx) signal inputted through a first port of a dualduplexer in a transmitting input unit (Tx_1) of the dualduplexer and outputting a resultant signal to a low noise amplifier through a second port; b) performing low noise amplification on the signal inputted to the low noise amplifier, performing high power amplification in a high power amplifier, and outputting a resultant signal to a third port of the transmitting output unit (Tx_2) of the dualduplexer; and c) radiating the signal inputted through the third port in the transmitting output unit (Tx_2) of the dualduplexer to the outside through a fourth port by performing filtering.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram illustrating a repeater using duplexers according to an embodiment of a prior art;

FIG. 2 is a block diagram showing a repeater using duplexers according to another embodiment of the prior art;

FIG. 3 is a block diagram describing a dualduplexer having a matrix structure in accordance with an embodiment of the present invention;

FIG. 4 is a diagram illustrating a method for forming a dualduplexer having a matrix structure in accordance with an embodiment of the present invention; and

FIG. 5 is a block diagram describing a dualduplexer having a matrix structure in accordance with another embodiment of the present invention.

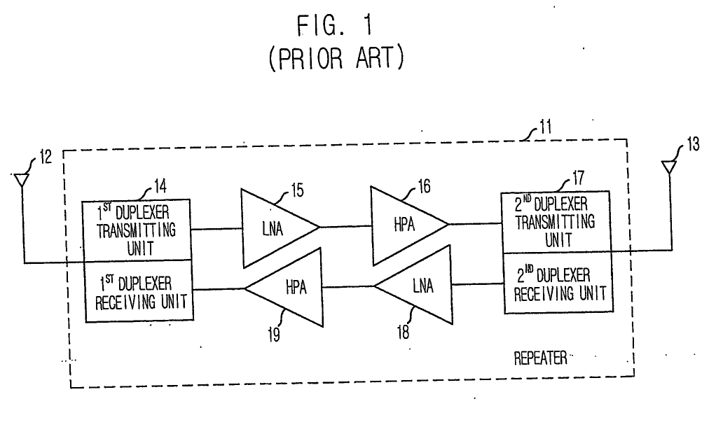

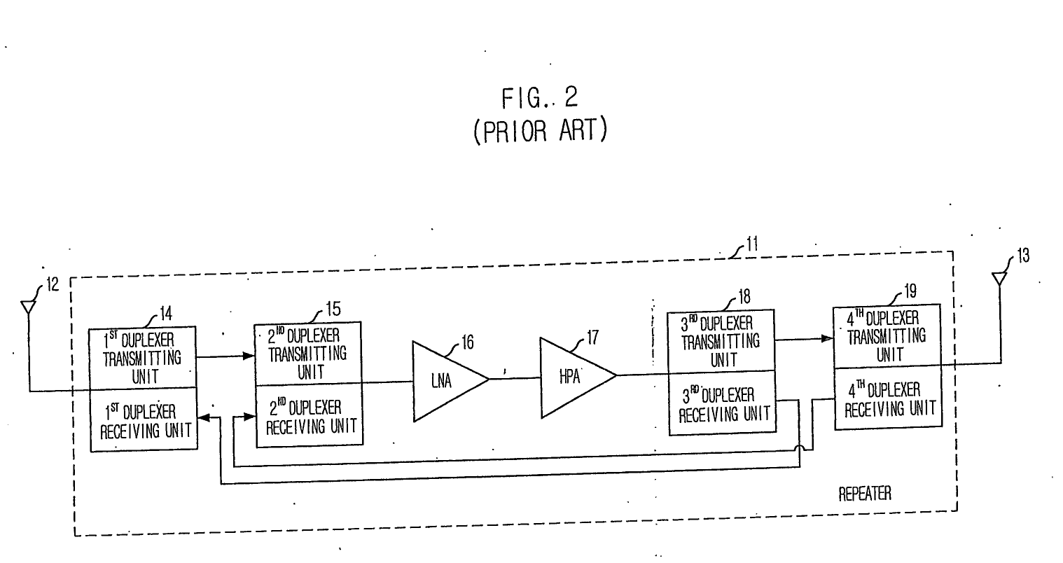

### BEST MODE FOR CARRYING OUT THE INVENTION

Other objects and aspects of the invention will become apparent from the following description of the embodiments with reference to the accompanying drawings, which is set forth hereinafter.

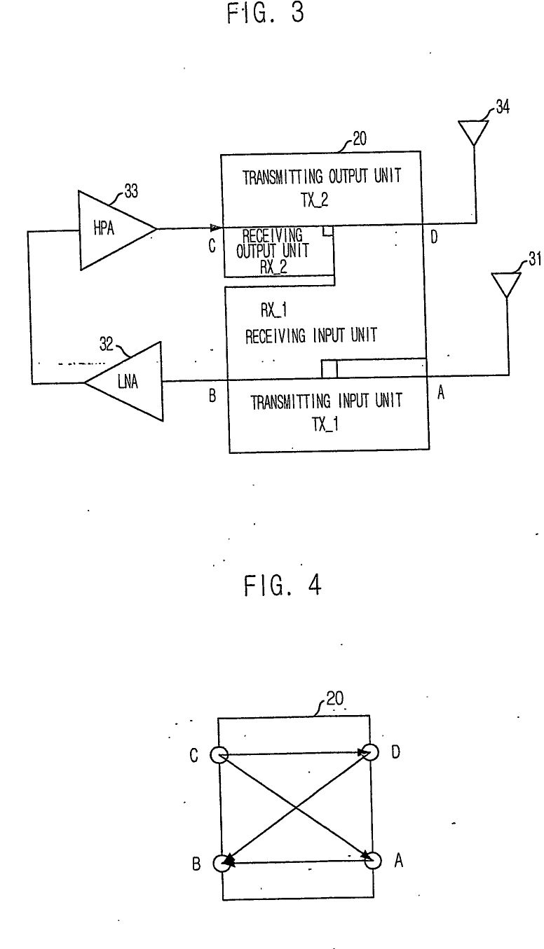

FIG. 3 is a block diagram describing a dualduplexer having a matrix structure in accordance with an embodiment of the present invention.

As shown, a transmitting (Tx) signal from a base station is inputted to a port A of a dualduplexer 20 having a matrix structure through a link antenna 31 and outputted through a port B with its frequency separated in a transmitting input unit (Tx_1) of a first duplexer. The signal outputted from the port B is amplified to minimize noise in a low noise amplifier (LNA) 32 and it is amplified into a high power linear signal in a high power amplifier (HPA) 33 and inputted to a transmitting output unit (Tx_2) of the second duplexer in a port C of the dualduplexer 20 having a matrix structure. The transmitted signal of the transmitting output unit (Tx_2) goes through frequency separation again and it is radiated to the outside through a port D and a service antenna 34.

On the contrary, a received (Rx) signal received through the service antenna 34 is inputted through the port D of the dualduplexer 20 having a matrix structure, goes through frequency separation in a receiving input unit (Rx_1) of the first duplexer, and is outputted to the LNA 32 through the port B. The LNA 32 performs low noise amplification on the outputted signal and outputs the resultant signal to the port C of a receiving output unit (Rx_2) of the second duplexer in the dualduplexer 20. The receiving output unit (Rx_2) of the second duplexer performs frequency separation again on the received signal and radiates the resultant signal in the direction of the base station through the port A and the link antenna 31.

Hereafter, the operation of the dualduplexer having a matrix structure will be described with reference to FIG. 4.

FIG. 4 is a diagram illustrating a method for forming a dualduplexer having a matrix structure in accordance with an embodiment of the present invention.

As shown, the dualduplexer 20 of the present invention which has a matrix structure includes ports A, B, C and D, and each port has the following characteristics.

The port A is matched with the ports B and C with different frequency characteristics and it is independent from the port D.

The port B is matched with the ports A and D with different frequency characteristics and it is independent from the port C.

The port C is matched with the ports A and D with different frequency characteristics and it is independent from the port B.

The port D is matched with the ports C and B with different frequency characteristics and it is independent from the port A.

In accordance with the present invention, an amplifier of a transmitting/receiving path can be used in common. The dualduplexer 20 having a matrix structure that minimizes the loss in the transmitting/receiving path has the following characteristics and operation principles.

As illustrated in FIG. 4, an input signal inputted from the port A is separated in the direction of the port B, passes through internal constituents (now shown) and is inputted to the port C. The signal is separated in the direction of the port D in the port C and outputted.

On the contrary, the signal inputted to the port D is separated in the direction of the port B, passes through the internal constituents (not shown) and is inputted to the port C. The signal is separated and outputted in the direction of the port A in the port C.

The dualduplexer of the present invention that has a matrix structure is described by taking an embodiment in which the dualduplexer is applied to a general repeater. The receiving portion of the dualduplexer having a matrix structure is crossed in the embodiment, but the scope of the present invention is not limited to the general repeater and it is obvious to those skilled in the art that the transmitting portion can be crossed as well.

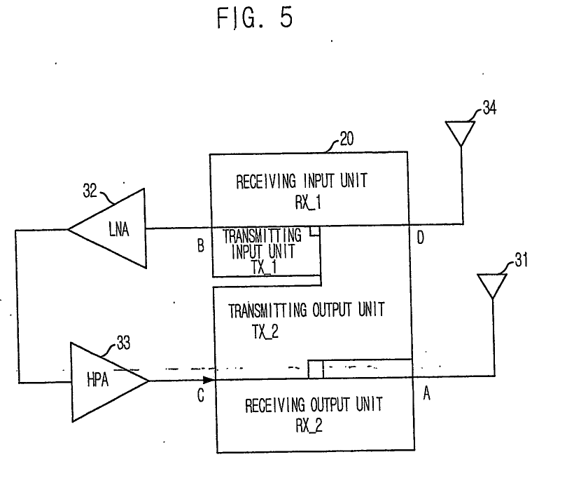

Hereinafter, another embodiment where the transmitting portion of the dualduplexer is crossed will be described with reference to FIG. 5.

FIG. 5 is a block diagram describing a dualduplexer having a matrix structure in accordance with another embodiment of the present invention.

As shown, a transmitting (Tx) signal transmitted from the base station is inputted through the link antenna 31 and the port A of the dualduplexer having a matrix structure. A transmitting (Tx) signal inputted through a port A is filtered in the transmitting input unit (Tx_1) of the dualduplexer, passes through the port B and is amplified in the LNA. The amplified signal is amplified in the HPA, filtered in the transmitting output unit (Tx_2) of the dualduplexer through the port C, and radiated to the service antenna 34 through the port D.

On the contrary, a receiving (Rx) signal received through the service antenna 34 is inputted through the port D of the dualduplexer having a matrix structure, filtered in the receiving input unit (Rx_1) of the duplexer, amplified through the port B, the LNA and the HPA, filtered in the receiving input unit (Rx_2) of the duplexer through the port C, and radiated through the port A.

As described above, the present invention can bring an effect of dividing a dualduplexer into four duplexers, prevent the generation of reception noise due to low-loss transceiving effect through integration, and increase the efficiency of transmission power.

While the present invention has been described with respect to certain preferred embodiments, it will be apparent to those skilled in the art that various changes and modifications may be made without departing from the scope of the invention as defined in the following claims.

What is claimed is:

1. A dualduplexer having a matrix structure, comprising:
a dualduplexing means including a transmitting input unit, a receiving input unit, a transmitting output unit and a receiving output unit, wherein the transmitting input unit, the receiving input unit, the transmitting output unit and the receiving output unit are used in common and the transmitting input unit, the receiving input unit, the transmitting output unit and the receiving output unit are connected in the form of a matrix.

2. The dualduplexer having a matrix structure as recited in claim 1, further comprising:
a low noise amplifying means for performing low noise amplification on a signal outputted from an input port of the dualduplexing means; and
a high power amplifying means for performing high power amplification on the signal outputted from the low noise amplifying means and transmitting the amplified signal to the dualduplexing means.

3. The dualduplexer having a matrix structure as recited in claim 1, wherein the dualduplexing means includes:
a first port for transmitting/receiving signals to and from a base station;
a second port for outputting the signals with separated frequency which are inputted from the transmitting input unit and the receiving input unit to the low noise amplifier;
a third port for receiving a signal from the high power amplifying means; and
a fourth port for outputting a high-power-amplified transmitting signal and receiving a signal transmitted from the outside.

4. The dualduplexer having a matrix structure as recited in claim 3, wherein the first port is matched with the second and third ports with different frequency characteristics and the first port is independent from the fourth port; the second port is matched with the first and fourth ports with different frequency characteristics and the second port is independent from the third port; the third port is matched with the first and fourth ports with different frequency characteristics and the third port is independent from the second port; the fourth port is matched with the third and second ports with different frequency characteristics and the fourth port it is independent from the first port.

5. A method for fabricating a dualduplexer having a matrix structure using an amplifier in common, comprising the steps of:
a) filtering a transmitting (Tx) signal inputted through a first port of a dualduplexer in a transmitting input unit (Tx_1) of the dualduplexer and outputting a resultant signal to a low noise amplifier through a second port;
b) performing low noise amplification on the signal inputted to the low noise amplifier, performing high power amplification in a high power amplifier, and outputting a resultant signal to a third port of the transmitting output unit (Tx_2) of the dualduplexer; and
c) radiating the signal inputted through the third port in the transmitting output unit (Tx_2) of the dualduplexer to the outside through a fourth port by performing filtering.

6. The method as recited in claim 5, further comprising a step of:
d) if a signal is received through the fourth port from the outside, filtering the received (Rx) signal in a receiving input unit (Rx_1) of the duplexer, amplifying the filtered signal in the low noise amplifier through the second port and in the high power amplifier, filtering the amplified signal in a receiving output unit (Rx_2) of the second duplexer through the third port, and radiating the filtered signal through the first port.

7. The method as recited in claim 6, wherein the first port is matched with the second and third ports with different frequency characteristics and the first port is independent from the fourth port; the second port is matched with the first and fourth ports with different frequency characteristics and the second port is independent from the third port; the third port is matched with the first and fourth ports with different frequency characteristics and the third port is independent from the second port; the fourth port is matched with the third and second ports with different frequency characteristics and the fourth port it is independent from the first port.
